(19) United States
(12) Patent Application Publication
(10) Pub. No.: US 2025/0065490 A1
(43) Pub. Date: Feb. 27, 2025

(54) DEVICE AND SYSTEM AS HUMAN INTERACTIVE SURFACE

(71) Applicant: ECOLE POLYTECHNIQUE FEDERALE DE LAUSANNE (EPFL), Lausanne (CH)

(72) Inventors: Jamie PAIK, LAUSANNE (CH); Fabio ZULIANI, MORGES (CH); Neil CHENNOUFI, Nyon (CH)

(21) Appl. No.: 18/726,255

(22) PCT Filed: Jan. 4, 2023
(86) PCT No.: PCT/IB2023/050059

§ 371 Date: Jul. 2, 2024

(30) Foreign Application Priority Data
Jan. 12, 2022 (WO) PCT/IB2022/050216

(51) Int. Cl. B25J 9/00; B25J 9/10; B25J 9/16

(52) U.S. Cl. CPC B25J 9/0051; B25J 9/1065; B25J 9/1623

(57) ABSTRACT

A force-feedback surface that creates and modulates distinctive profile and stiffness to interact with a user in contact thereto, the surface being functionally independent to be used as a single module but can be customized to extend the application in diverse fields by assembling in series, parallel, or any combinations to form a multimodular system.

### EARLIER APPLICATION

The present application claims priority to the earlier application No. PCT/IB2022/050216 filed on Jan. 12, 2022 in the name of ECOLE POLYTECHNIQUE FEDERALE DE LAUSANNE (EPFL), the content of this earlier application being incorporated in its entirety by reference in the present application.

### TECHNICAL FIELD

The invention belongs to the field of mechanics, robotics and electronics. In particular, the invention relates to force-feedback surfaces that create and modulate distinctive profile and stiffness to interact with a user in contact.

### BACKGROUND ART

With the recent technological advancements, needs and challenges, our daily life is permeated with high-tech solutions that often involve technologies like robotics, virtual reality or augmented reality. The recent COVID pandemics and the announcement of the creation of a “Metaverse”, among others, are boosting even further those technologies, due to incoming compelling needs to e.g. teleworking, home training and home rehabilitation.

The present invention tries to tackle and overcome at least partially those challenges by providing a novel robotic solution for entertainment, sport training and distance healthcare, among others.

### SUMMARY

According to one aspect of the present invention, a device and multimodular system is proposed, having interesting features and capabilities as interactive human surfaces for a plurality of applications. For example, a force-feedback surface is proposed that creates and modulates force, velocity, topology and stiffness profiles to interact with a user in contact with the force-feedback surface. Preferably, the surface is functionally independent to be used as a single module but can be customized to extend the application in diverse fields by assembling in series, parallel, or any combinations.

With this mechanical capacity, preferably the device and multimodular system can diagnose, detect progress, and produce a range of motions with different intensities of the required physical interactions. Such a device or system can have applications in sports, therapies, physical entertainment, home automation, communications, and advertisements where e.g. the users can closely interact with the platform while giving and receiving multiple-degrees-of-freedom force feedbacks.

The interactive surface also potentially allows to manipulate objects through various inter collaboration of the modules via high-level control algorithms through the force-feedback modules that can transmit the control information as well as the actuation information. In embodiments, the surface can use an interactive closed-loop control to move forward, rotate or flip any object of reasonable size compared to each module. The interactive surface can discriminate different object types, sizes, orientation as well as their position and speed on the surface so that they can be controlled. The inherent modular design of the system of the invention can be extended with intermodular links to create a continuous surface to optimize the controllability of the objects on the interactive surface.

In embodiments of the invention, the interactive surface can include or can be operatively connected to load-bearing folding joints to withstand the dynamic interactions with the human body (hands, feet, shoulders, knees, with human body scale weight), as well as other objects, part of external environment or groups of humans. The actuation transmission also uses these folding joints. Also, according to an aspect of the present invention, a manufacturing method for such device or system is provided, specifically for manufacturing the folding joints. For example, the manufacturing steps of a method to manufacture the folding joint can be such that 1) the load of the joints are maximized for providing support throughout their performance and lifetime in a large range of size, dimensions, ranges of motion, loads supported and dynamics achievable 2) provide for ease of manufacturing for mass production with a very high customizability of all the aspects of the structure though layer-by-layer manufacturing process allowing to customize each layer in terms of material, thickness, number of different or similar layers, dimensions, assembly and interfaces, in order to achieve a wide range of achievable strokes, forces and sizes that can be specifically achieved towards a defined application 3) provide for a modular system that allows for multi-assembly as well as disassembly for change of configurations and components, in a wide range of resolution going from several modules on a fingertip to one single module for a group of humans.

Some additional features can also be added in the customization process such as force-limiting or position-limiting end stops to prevent the system to break, a heterogenous inherent stiffness of the modules or heterogenous actuation, sensing or structure capabilities and ranges of motion to perform a broader variety of tasks

It is also proposed the control architecture or system for any interactive interface that receives and gives force feedback back to the environment for different applications (i.e. body dynamics, vision/audio adaptive trajectories and force feedback, application-specific progressions, etc). For this control architecture or system, the number of DoFs, assembly type, choice of actuation, sensing and transmissions of the device work as independent parameters.

The patent Foldable Machines, see reference [1], is targeting the fabrication process of machines made of sheets of materials folded into a complete functional system. The scale of use of such technique is limited to a few centimetres and accounts only for small loads. The technical use of such parts and linkages are designed as kinematic and not as load-bearing. Millimetre scale machines as well as origami folding wings drones, see references [2-3], are accounting for multi-material system bonded together but are again limited to small scales, non-load bearing application and no dynamic behaviour as being limited to single unfolding patterns to deploy a system and not for a continuous use.

Robogami, see reference [4], is the first origami system with continuously actuated joints for actual motion but the speed is limited, and the load is minimized to a few tens of grams without any closed-loop control with the environment.

High-load capacity origami wheels, see reference [5], did launch the scope of human-scale loadable origami structures to change dynamically the shape of origami wheels mounted on a rover. The origami joints are however passively actuated to change the shape in one of the two bistable positions and are therefore not in direct interaction with the load. Bistabilities to shape larger folded structures have also been investigated for meter scale structures, see reference [6], that can shelter humans.

Finally, pneumatic printed actuators for self-actuating robots, see reference [7], have limited sizes and loads for human-scale interaction as the pneumatic actuation has a low energy density.

To the contrary, high load joints as proposed by the present invention aim, in a non-limiting embodiment, at large human-scale structures that can withstand human body weight loads in static as well as dynamic modes. The inherent compliant transmission between the actuation and the structure allows to leverage both the compliant structure and the high torque and large stroke actuators. According to an aspect, the composite construction with different materials accounting for the structural rigid parts and the flexible parts give substantial value on a long-lasting resilient system. The use of different types of materials for the various parts (rigid and flexible) allows to customize specifically each part with defined characteristics to easily meet technical requirements. Conventional linear actuators as well as pressure sensors allow to reach load-bearing application without accounting for the specific limitations of small-scale origami technologies.

The scale of the bio-inspired compliant joints, see reference [8], is focusing on small scale to move fractions of kilograms. The inherent design of the system makes it poorly customizable to any application and especially not suited for large strokes for human-interactive devices.

The monolithic approach of the Movement transmission patent, see reference [9], drastically limits the operational size of the system. The angular stroke is also drastically limited as each flexible joint can withstand only a few degrees compared to the proposed work which can allow several tenth of degrees. Additionally, the sheet materials used in the frame of the present invention are also much more affordable and lightweight compared to a monolithic system made of steel, and it is thus beneficial for human-machine interactions high dynamical constraints.

The multi-pivot hinge cover, see reference [10], reaches a similar scale compared to the system and device of the present invention, but is solving the large stroke challenge by stacking several hinges togethers which dramatically complexifies the manufacturing. The loadability of such system is also relatively low and is not meant to withstand dynamic loads and motion underload, but rather to protect the cabling system between the two electronical sides of the system.

The multi-material compliant mechanism used for mobile millirobots, see reference [11], have demonstrated high resistance to fatigue but with minimal loads and at small scale. Replicating the same complex design for high loads and high dynamics would require very expensive materials and processing.

The herein proposed device system allows for large DoF (degree of freedom) structures inherent to the layer-by-layer manufacturing technology as opposed to the monolithic approach presented in references [8-9]. The stroke of the joints is also drastically increased thanks to the layer-by-layer manufacturing methods which allow to easily account for larger joints length to increase the angular stroke. Customizability of the system is key to have a large scalability both in terms of size and quantity of modules that can be produced in a row. The multi-material composite approach allows to keep the same level of portability and weight while bringing a high force and torque capabilities to flexible joints.

According to an aspect of the present invention, the inherently simple layer-by-layer multi-material manufacturing design allows to have a great customizability of the system in terms of material selection with a range of sizes that can go from a few centimeters to a few meters for larger multi-modal structures. The scalability of the manufacturing both in terms of size and quantity are very favorable as all the system is made of 2D pieces stacked together which is highly automatable and resilient. This unique scalability permits to create large arrays of modules to equip complete human environments such as a whole room or a dedicated indoor space for novel interactive immersive applications. The additional interaction engine brings the novel system-wide control to bring interaction to a whole set of modules creating a complete environment interacting with humans in complex ways.

The “layer-by-layer approach” is declined in the three specific domains listed below:
layer-by-layer control states that include activated and deactivated states to embed the proposed surface into any currently existing human artificial or organic environment thanks to their low profile. This implies that devices and system of the invention can be embedded into any surface of any scale, at any resolution with an interactive feedback thanks to their high degrees of freedom and sensorized modules that can be customized to specific load, stroke and control needs in static and dynamic modes;
a layer-by-layer manufacturing process allowing to parallelize the whole production of the different elements up until the assembly process, thanks to a layered process involving diverse materials and equipment depending on the thickness and the material strength, including but not limited to lasers, waterjet, CNC, milling machine, lathe or any conventional manufacturing process allowing to form and shape 2D material. All parts can be processed completely up until the final assembly, including pre-assembly of subsystems with discrete elements such as sensors, electronic components, computing systems and actuators;
a layer-by-layer design using only 2D parts which allows to customize the specific design very easily and efficiently to defined requirements without changing the whole design and the major design key points. Customizing is done through material selection, change of thickness of layers and their number, the size, position, and orientation of all the parts as well as a combination of all above. This allows to tune the performance to specific needs and use cases and to tune overtime a given device.

According to some embodiments, the herein proposed interactive surface of the device or system can be made of a set of modules built with flexible load-bearing joints. This allows to achieve high complexity of a structure with a simple manufacturing while keeping a great lifetime expectancy compared to complex mechanisms. The specific design used also allows to have large degrees of freedom structures and complex motions with large strokes and dynamic motions necessary for human-interaction. The interactive surface designed as a set of modular systems allows to reconfigure at will the complexity, shape, and size of the whole system to broaden as much as possible the possibilities with a single set of modules. Serial as well as parallel use allows to multiply the strokes, the forces and the dynamics achievable by the system at will.

According to an aspect of the present invention, the load-bearing joints can be used to bind or tie several parts together in a compliant but strong manner to withstand large forces allow to have an interactive compliant structure capable of motions and stiffness feedback at human-scale. The load-bearing joints allow to go from fingertip forces to human-weight counter loads to move a whole body in order to build complete interactive environments. They also allow to attach large torque and large stroke actuators to compliant interactive structures.

The inherent layer-by-layer design of the load-bearing joints allow to tune the thickness of the stiff panels around the flexible joints. The thickness is defining the maximal angle of flexure of the two panels which accordingly allows to include in the design a maximal angle to be reached which coupled to the angular stiffness of the joints allow to integrate in the design a maximal load for each joint before they become a rigid connection between the two rigid panels.

One further advantage of the designed device and system relies in the fact that the actuation part can be embedded in the void portions in between the lower ground and the top platform in a very thin space, so to have a very high aspect ratio of the structure. A sensing layer comprising various sensors can also be embedded in the top platform and electrically linked to the ground where the whole computation and algorithmic may be embedded.

This allows to have a flat structure that can be included into any currently existing floor, wall, ceiling or piece of furniture without any extra need of space. This is true to any resolution as the actuation, the sensing and the computational power are embedded inside the flat folded structure while in idle mode. The extension mode height of the top platform can go up to 20 times the thickness of its folded state while keeping its mechanical properties at any time of the process.

In sum, three main challenges can be addressed with at least some aspects of the herein presented invention:
The use of spring elements or other flexing means for the flexible joints to achieve large motions and high-DoFs system couple with high loads are preferably implemented by multi-material composite solutions, and such implementation has shown to be challenging in this uncharted technical field. In particular the combined use of spring steel sheets for the flexible parts to optimize wear and durability with rigid parts made of acrylics which optimizes the weight and ease of manufacturing, is a preferable aspect for implementing the spring elements or flexing means, and a design choice made to achieve the above stated goals;
the implementation of the actuation on such flexible joints-based design is also specifically challenging due to the necessity to assemble conventional high-load and high-dynamics actuators with flexible large-deformation joints. The sensing had to be implemented in the rigid parts of the flexible structure as well while still distributing the load sensing on the various sub-systems of the device;
the control engine of a set of modules in an interactive way requires to assemble a larger than average quantity of actuators and sensors. Taking decisions is especially challenging as the interactive and therefore unexpected behaviour of humans coupled with the large quantity of inputs and outputs makes it a large dimensions problem.

Generally speaking, envisioned systems would impact the whole human environment in domains such as furniture, architecture, or any kind of infrastructure that is directly in contact with humans, at various scales, including or a complete wearable device morphing around a human or a group of humans in an organic way. Among various uses, two major fields exist for commercial application of the herein presented device and system, including health and entertainment.

The system can be very well used for health rehabilitation with small to large motions with a complete sensory feedback useful for direct prognosis to adapt the needs and the progression of a patient, firstly for the lower limbs but this could be adapted to the back, the upper limbs and even any articulation with specifically designed mechanical hardware. Market seems to be looking for mechanical solutions to bring devices that withstand human-scale loads, high dynamics and large strokes for rehabilitation while keeping an acceptable complexity and that can be used by the medical field personnel.

The second commercial application or field includes entertainment application that is mostly focused on video or interactive games that could take advantage of a new human-scale interactive surface to immerse the players much more than currently existing devices. The modularity and the scalability of the system is specifically interesting as it could allow to adapt to a large range of potential specific application needs.

Finally, sport training and exercising could be at the intersection of the two application domains in providing playful physical training with adaptation in the intensity and a feedback on the performances and even potentially on the risks of injuries.

According to at least some aspects of the present invention, an electromechanical interactive module is provided, preferably comprising:
an origami parallel robot;
a base plate operatively coupled with a first end of the origami parallel robot; and
a distal plate operatively coupled with a second end of the origami parallel robot.

The electromechanical interactive module includes an actuated parallel platform system having preferably a substantially planar base and an actuation structure (origami parallel robot) constituted of n limbs or legs, with n being at least two (2), each limb comprising:
n basal linking members pivotally attached via basal hinge joints to a base plate at first ends of the basal linking members, with the basal hinge joints allowing a single DoF between each of the basal linking members and the base plate;
n distal linking members pivotally attached via distal hinge joints to a distal plate at first ends of the distal linking members, with the distal hinge joints allowing a single DoF between each of the distal linking members and the distal plate; and
a plurality of connecting member pairs, each member of the pairs being pivotally attached:
at a first end, to a corresponding basal linking member at a second end of the corresponding basal linking member via a first hinge joint; and
at a second end, to a corresponding distal linking member at a second end of the corresponding distal linking member via a second hinge joint,
each member of the pairs further comprising a third hinge joint, the first, second and third hinge joints of a limb intersecting in a spherical motion center of the limb.

In some embodiments, the device or the system preferably further comprises N actuators, with N=n, mounted in fixed relationship relative to a base plate and being connected to the at least n basal linking members for pivoting the basal linking members about pivot axes of the basal linking members.

In some embodiments, the device or system can include a base, three movable legs or limbs, and a movable platform (distal plate). The movable platform can be rotatably attached to each of the three movable legs, and three mechanical transmission mechanisms individually actuate the three movable legs.

The connecting member pairs are preferably foldable middle section pivotably connecting a basal linking member to a distal linking member, according to an origami manufacturing method.

In operation, the movable legs are configured to move the movable, distal platform with one translational degree of freedom and two rotational degrees of freedom by the three mechanical transmission mechanisms of the parallel robot.

According to another aspect of the present invention, a multimodular system can be provided. In particular, according to another aspect, a multimodular system can be provided that comprises an array of electromechanical modules as described herein. In one embodiment, the array of modules is located on a support, forming in embodiments integral part of the system and coupled with the base plates of the electromechanical modules.

According to still another aspect of the present invention, the multimodular system can be based upon two main “axes” defining the inventive concept thereof, namely 1) the use of an array of parallel manipulators and 2) the use of origami technology for the production of the parallel manipulators. The system has been implemented in an experimental setup taking into account several considerations, both of technical and commercial nature: the use of origami technology for the production of parallel robots, thereby became readily amenable for scaling up or down depending on the needs and circumstances, and can be therefore implemented in all-in-one, built-in systems including a plurality of parallel manipulators-based device modules in a single multimodular structure. Advantageously, the parallel manipulators can be easily coupled and interfaced both between them and with external or embedded computer devices or systems, programmed to move the parallel robots, thus coordinating everything depending on the needs and circumstances.

The combination of a parallel architecture with the origami manufacturing process provides numerous desirable advantages within the frame of the system, namely high versatility of design combined with robustness, relatively low cost production cost, ease of scaling, as well as appropriate workspace, speed and precision in motion to afford a plethora of stunning effects when it comes to the animation of the plurality of modules.

A multimodular system comprising an array of electromechanical devices embodied as parallel origami manipulators can move with respect to a base with expansion, tilting motions, rotations or combinations of those, thus expanding the range of possible motions beyond the limits of the currently imaginable systems. Additionally, the motion can be performed via a sensory system which can comprise for instance a camera/sensor system detecting a person load, position or even gesture, and moving one or more module accordingly; a touchscreen that allows the control of the module(s); embedded sensors so that the user can touch them directly for having a more direct interaction.

According to yet another aspect of the invention, the system can have multiple scales and a variety of shapes, depending on the needs, spanning from a few centimetres in size/diagonal/diameter (depending on the shape), such as a 20×20 cm in size for a square shaped panel, up to e.g. 1×1 meters.

Another object of the present invention relates to an interaction strategy and an interaction engine architecture for interactive physical systems in an artificial environment to create virtual physical interaction between different physical locations (FIG. 28). Said interaction strategy is focused on making the artificial environment immersive through a distributed number of interactive modules operably coupled together through the proposed interaction engine and interaction strategy. The simultaneous control of the whole array, or part of it, of modules, and the physical interaction between the various physical locations involving either humans, machines or the surrounding environment made of active or passive objects or entities, are key elements to create a truly immersive setting to link different physical locations through a virtual communication bridge both in terms of technical and machine-based data and immersive human experience through physical and psychological feelings.

The main aim is to create a fully modular system that can be used by a single user a plurality of users simultaneously, and that each user or set of users can interact with one single module, potentially shared, or a set of modules and can thus virtually communicate with physical, tangible and visual interactions through a virtual, artificial or physical environment from different physical locations, each provided with one or a set of modules. Furthermore, users can interact among themselves through the interactive set of modules even if they are not in the same physical location.

The above and other objects, features and advantages of the herein presented subject-matter will become more apparent from a study of the following description with reference to the attached figures showing some preferred aspects of the subject-matter.

### BRIEF DESCRIPTION OF THE DRAWINGS

FIGS. 1 to 15 show various embodiments and configurations of a single electromechanical interactive module according to some aspects of the invention, an array of modules according to some aspects of the invention, and various applications and features of the module or array of modules;

FIGS. 16A-16C, 22, 23 and 24 depict embodiments of the multimodular system according to the invention;

FIG. 18 depicts an embodiment of a single module according to the invention;

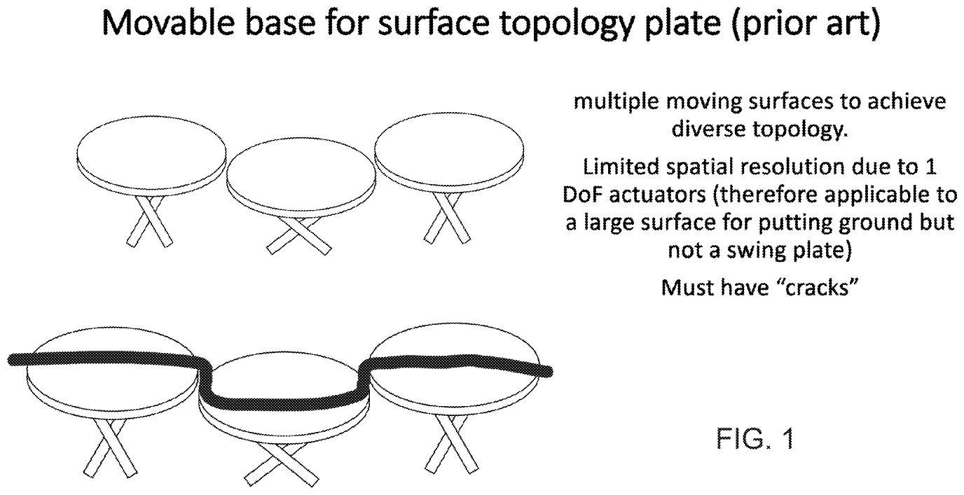

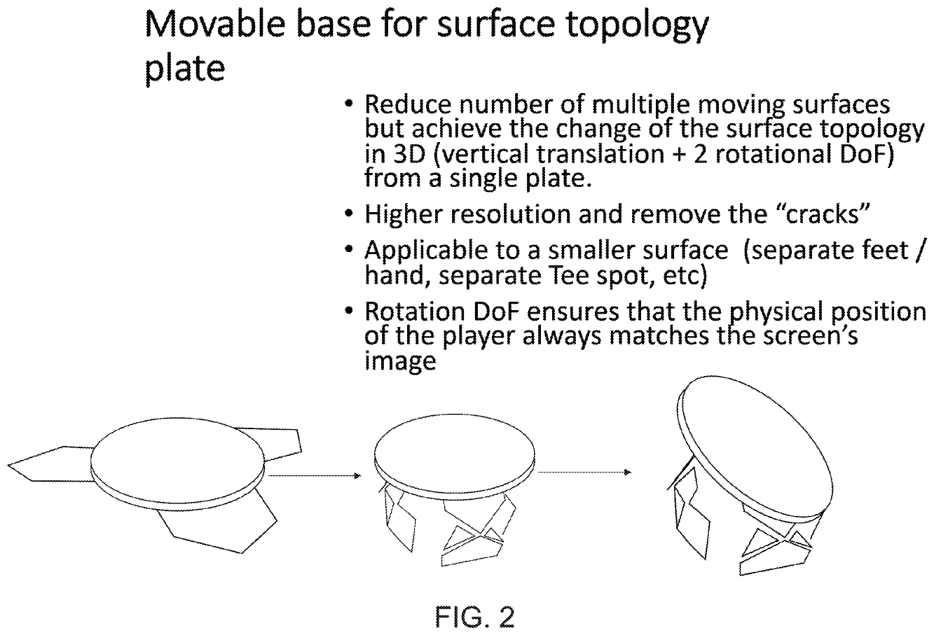

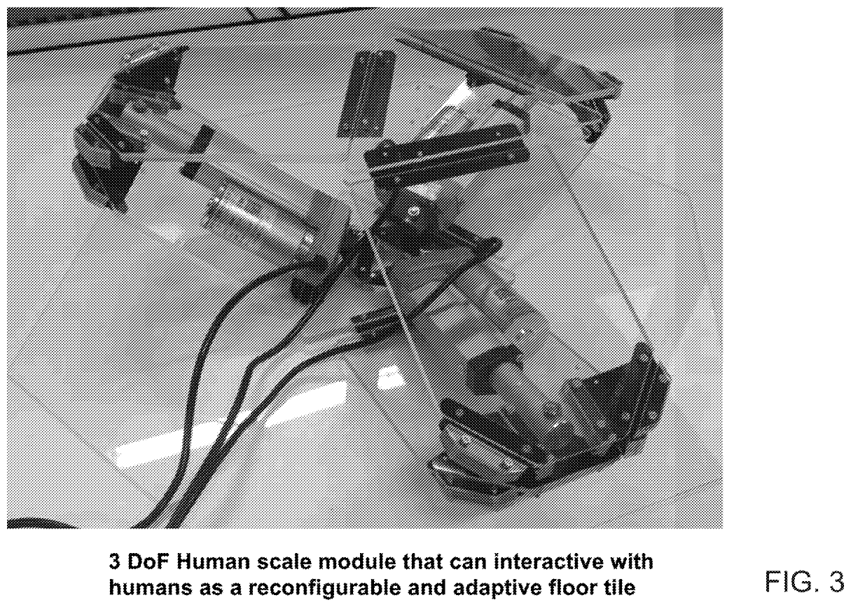

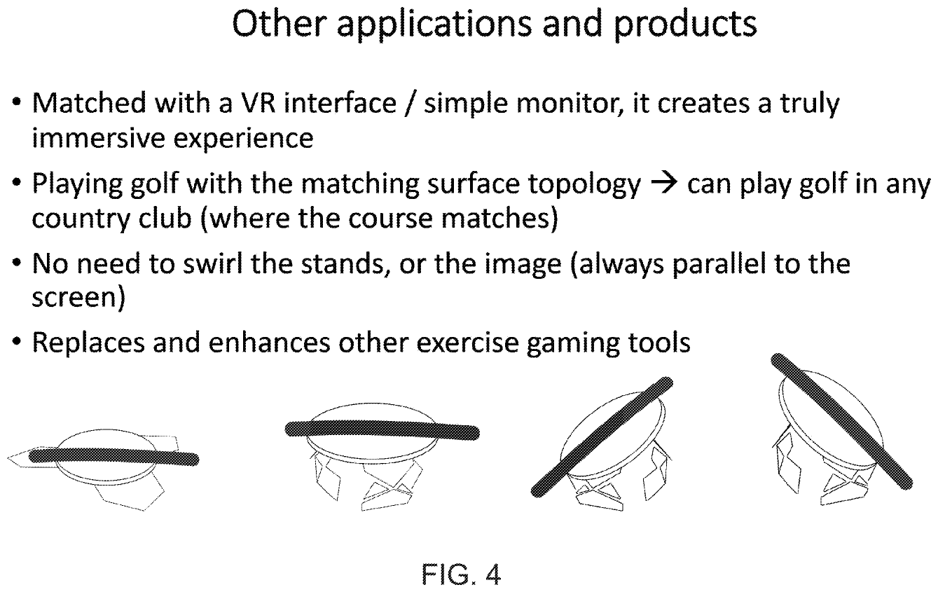

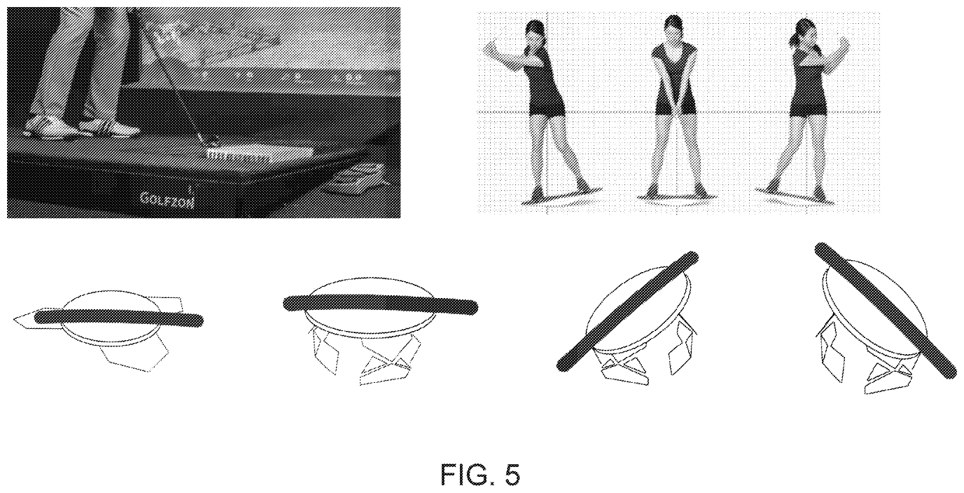

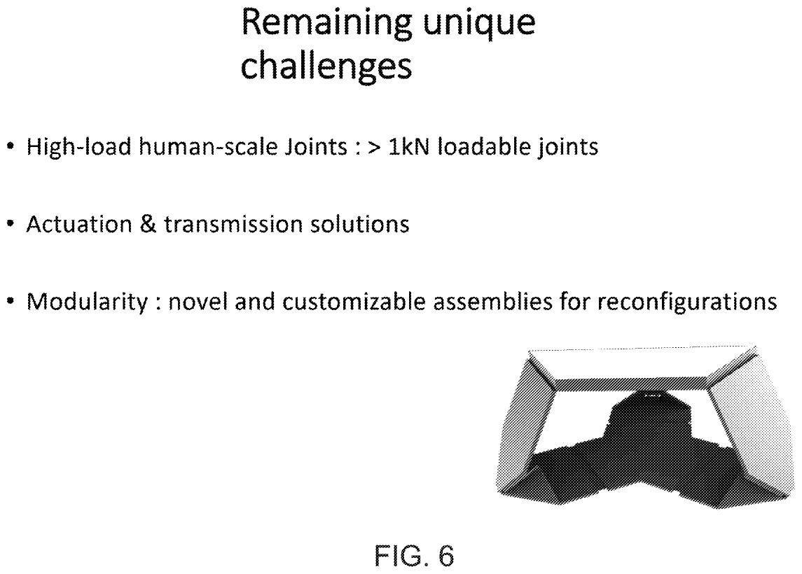

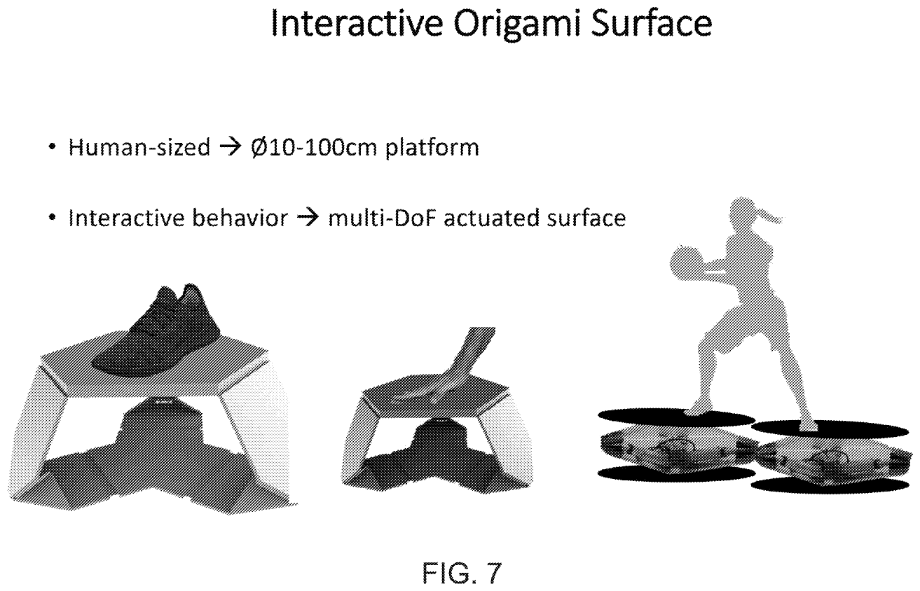

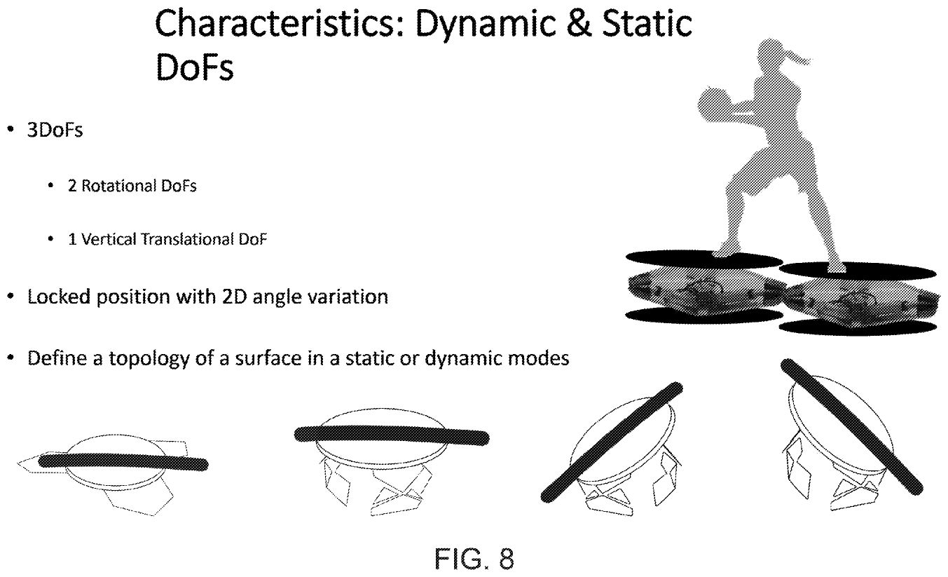

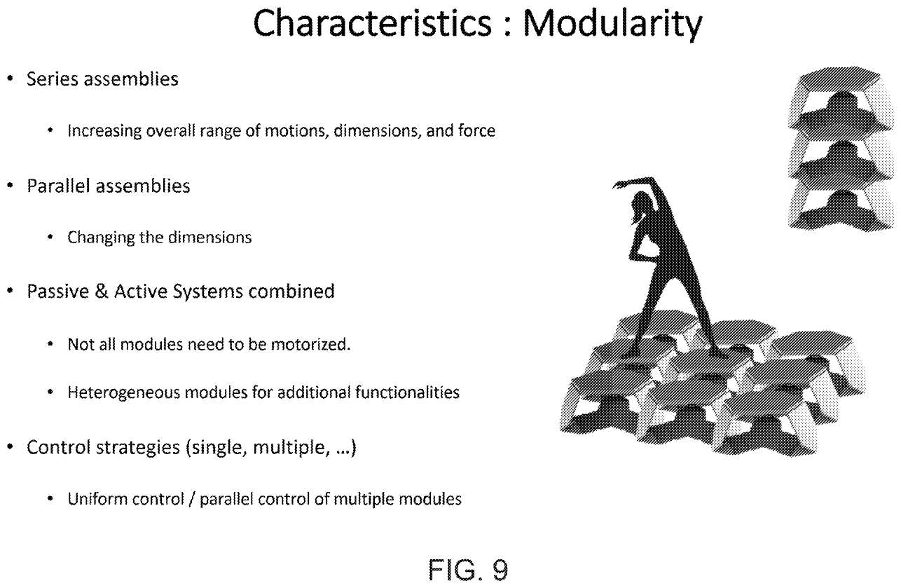

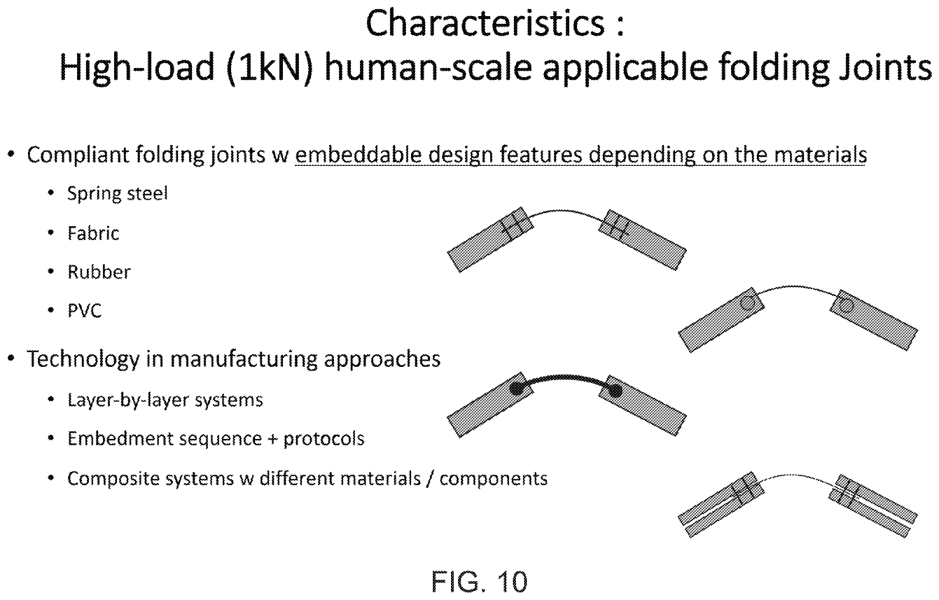

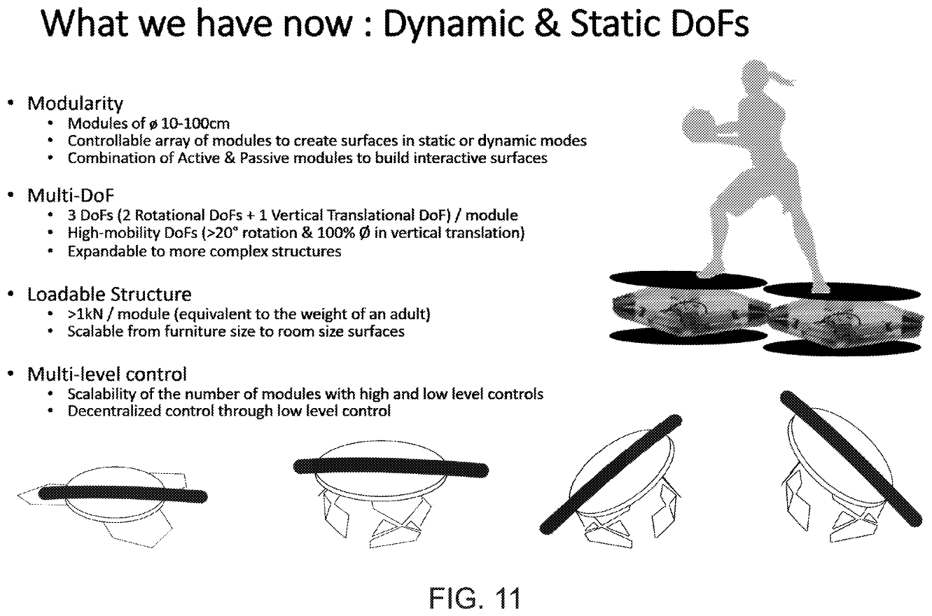

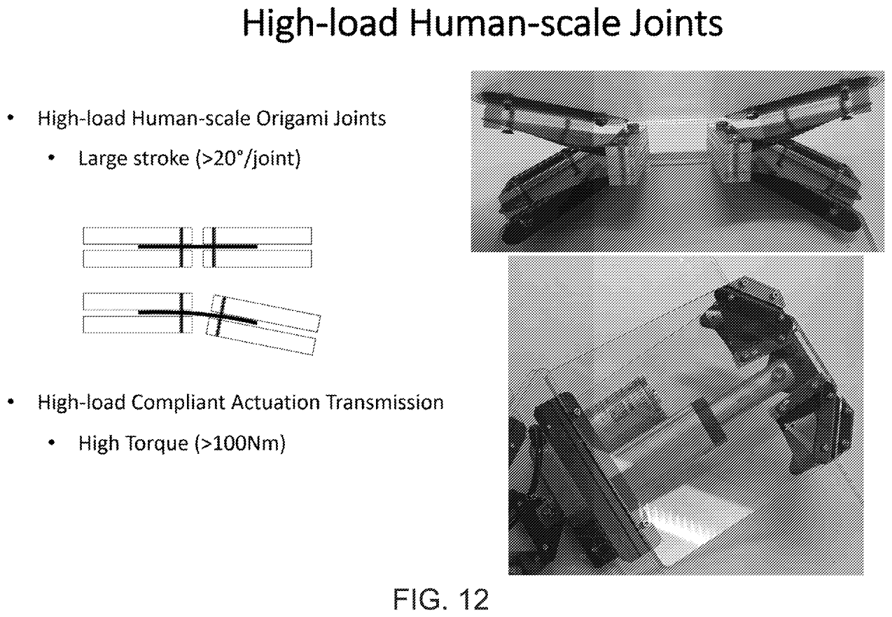

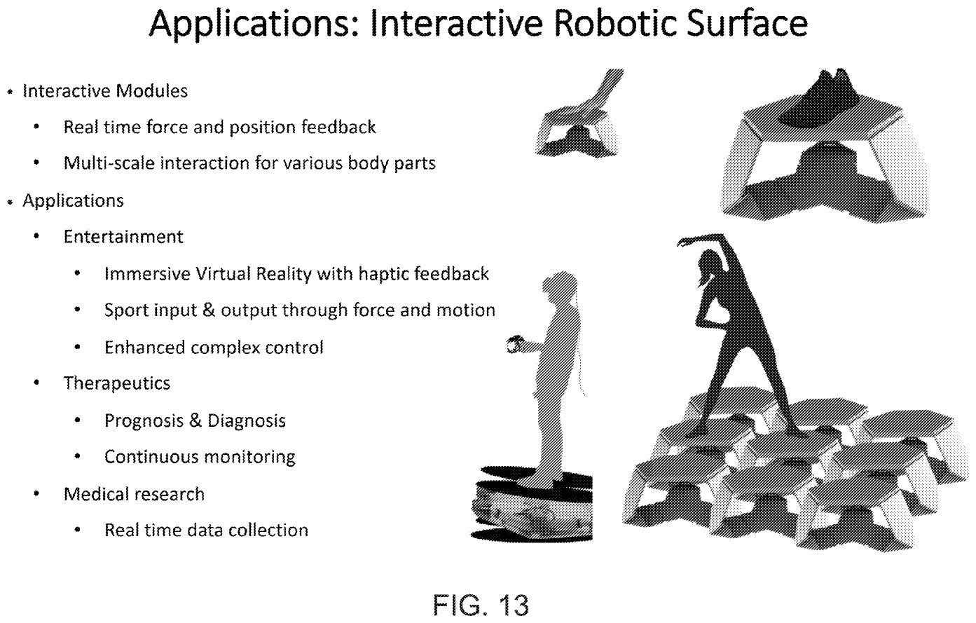

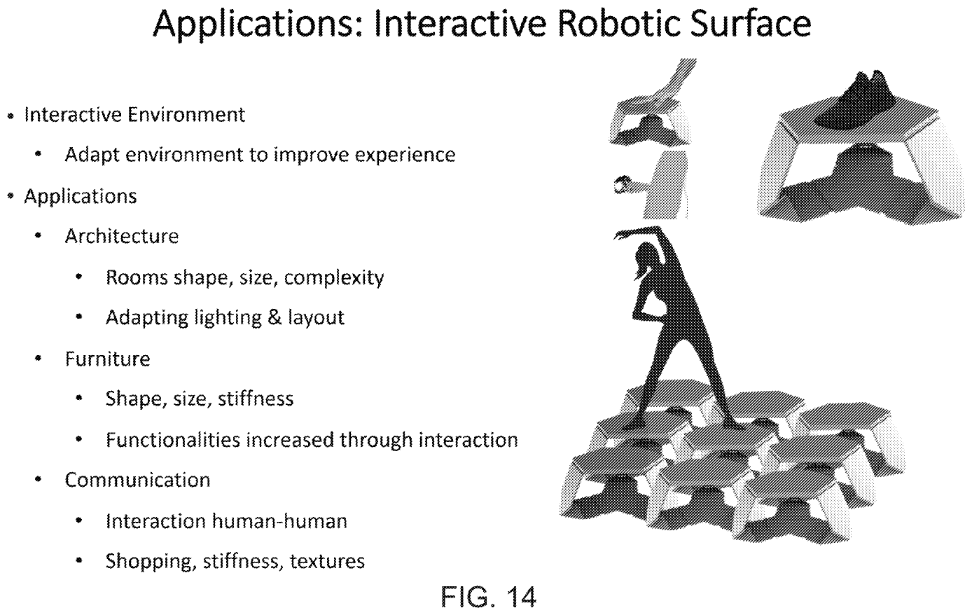

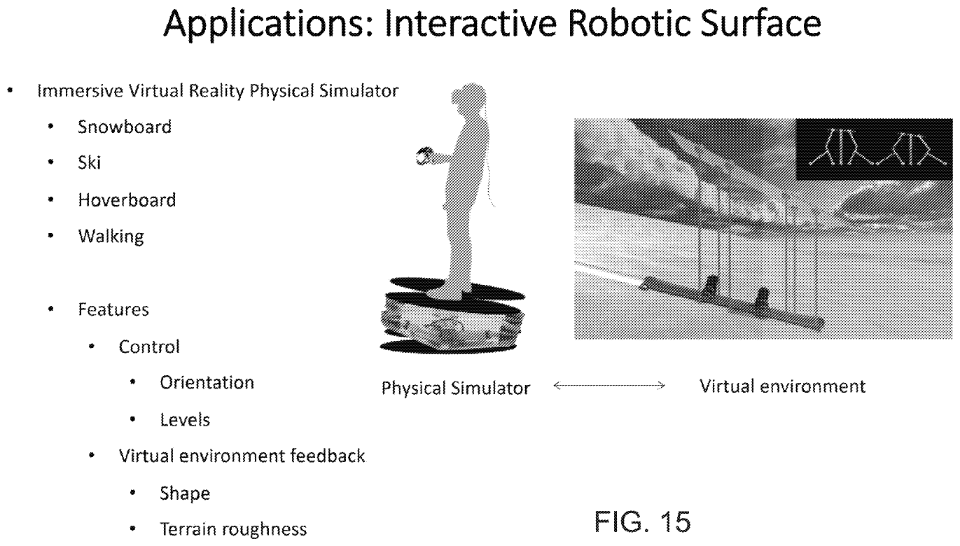

FIG. 17 depicts a detail of an embodiment of an origami-based limb of a parallel manipulator according to the invention;

FIG. 19 depicts embodiment of a parallel manipulator according to the invention;

FIGS. 20 and 21 depict two embodiments of multimodular system according to the invention operatively connected with a computer device for operating the system;

FIG. 25 depicts one embodiment of a parallel manipulator according to the invention configured to have a virtual, non-physical spherical motion center; FIGS. 26 and 27 show details of the origami-based limb of a parallel manipulator according to the embodiment in FIG. 25;

FIG. 28 schematically depicts an embodiment of the range of possibilities with the Interaction Strategy allowing to have a set of users using a set of modules in various location that may interact all together through a immersive virtual environment;

FIG. 29 shows a scheme of the tangible interaction engine data stream, showing user(s), physical platform(s), external applications and the network with other potential stakeholders;

FIG. 30 shows a scheme of the tangible interaction engine inner data streams and decisions-making units.

### DETAILED DESCRIPTION OF THE EMBODIMENTS

The subject-matter described in the following will be clarified by means of a description of those aspects which are depicted in the drawings. It is however to be understood that the scope of protection of the invention is not limited to those aspects described in the following and depicted in the drawings; to the contrary, the scope of protection of the invention is defined by the claims. Moreover, it is to be understood that the specific conditions or parameters described and/or shown in the following are not limiting of the scope of protection of the invention, and that the terminology used herein is for the purpose of describing particular aspects by way of example only and is not intended to be limiting.

Unless otherwise defined, technical and scientific terms used herein have the same meaning as commonly understood by one of ordinary skill in the art to which this invention belongs. Further, unless otherwise required by the context, singular terms shall include pluralities and plural terms shall include the singular. The methods and techniques of the present disclosure are generally performed according to conventional methods well known in the art and as described in various general and more specific references that are cited and discussed throughout the present specification unless otherwise indicated. Further, for the sake of clarity, the use of the term “about” is herein intended to encompass a variation of +/−10% of a given value.

The following description will be better understood by means of the following definitions.

As used in the following and in the appended claims, the singular forms “a”, “an” and “the” include plural referents unless the context clearly dictates otherwise. Also, the use of “or” means “and/or” unless stated otherwise. Similarly, “comprise”, “comprises”, “comprising”, “include”, “includes” and “including” are interchangeable and not intended to be limiting. It is to be further understood that where for the description of various embodiments use is made of the term “comprising”, those skilled in the art will understand that in some specific instances, an embodiment can be alternatively described using language “consisting essentially of” or “consisting of.”

In the frame of the present disclosure, the expression “operatively connected” and similar reflects a functional relationship between the several components of the device or a system among them, that is, the term means that the components are correlated in a way to perform a designated function. The “designated function” can change depending on the different components involved in the connection; for instance, the designated function of actuators operatively connected with a parallel robot is to allow the movement of the parallel robot. A person skilled in the art would easily understand and figure out what are the designated functions of each and every component of the device or the system according to some aspects of the invention, as well as their correlations, on the basis of the present disclosure.

A “kinematic chain” is an assembly of rigid bodies connected by joints to provide constrained (or desired) motion that is the mathematical model for a mechanical system. The rigid bodies, or links, are constrained by their connections to other links.

A “revolute joint” (also called “hinge joint”) is a one-degree-of-freedom kinematic pair used in mechanisms. Revolute joints provide single-axis rotation function used e.g. in folding mechanisms and other uni-axial rotation devices, while impeding translation or sliding linear motion.

A “parallel robot”, or “parallel manipulator”, is a device composed of two or more closed-loop kinematic chains in which an end-effector (mobile platform) is connected to a fixed base platform by at least two independent kinematic chains. Between the base and end effector platforms are serial chains (called limbs or legs). Typically, the number of limbs is equal to the number of degrees of freedom such that every limb is controlled by one actuator and all actuators can be mounted at or near the fixed base.

Parallel robot manipulators can be classified as planar, spherical or spatial manipulators in accordance with their motion characteristics. Parallel robots that can be used in conjunction with the herein presented device or system are spatial parallel robots. Compared to serial manipulators, parallel robots have the advantages of a higher precision, low inertia and higher operating speeds and accelerations.

“Origami”, the art of paper folding, has emerged as a powerful methodology for developing intelligent transformable robots, as explained in Rus et al., Nature Reviews Materials, Vol. 3, Issue 6, Page 101-112, 2018. Origami techniques have been adopted to design intelligent transformable robots; this technique allows for a 3D structure by erecting and folding a 2D layered material with crease patterns in which creases and panels are of equivalence of commonly used revolute joints and rigid links.

The ability to produce a functional robot from a flat sheet by mere folding can make the fabrication process fast and simple. A wide range of planar fabrication techniques (for example, lamination, photolithography, and printed circuit microelectro-mechanical systems (PC-MEMS)) can also be employed to impart and customize functionalities of origami robots. Made of paper-like structures, origami robots are of low cost and low weight. In addition, when reverted to planar sheets, origami structures can be easily stored and transported. Due to these interesting attributes, origami structures have been widely explored for e.g. space and biomedical applications. It is popularly assumed that origami folding patterns exhibit both flexibility along the hinges/creases and rigidity in the planes.

One advantage is the possibility to shrink complex mechanical systems to a very small size or foldable configurations, limiting the need of a trade-off between mechanism complexity and platform miniaturization and leaving freedom in system design with much fewer limitations for robot dexterity.

With reference to the Figures, one exemplary, non-limiting embodiment of some aspects of the invention are depicted, for both an electromechanical interactive module and a multimodular system. As a way of example, the Figures show a single module embodied as a 3 DoF parallel origami manipulator. A multimodular system (MMS) comprises an array of modules, with at least some of them comprising an origami parallel robot having 2 rotational DoF and 1 translational DoF. In a main embodiment, a multimodular system MMS comprises a support 1; and
an array of electromechanical device modules located on the support 1, each of said modules comprising:
an origami parallel robot 100;
a base plate 200 operatively coupled with both said origami parallel robot 100 and said support 1; and
a distal plate 300 operatively coupled with said origami parallel robot 100. For the sake of clarity, both the base plate 200 and the distal plate 300 are the end effectors of the origami parallel robot 100.

In preferred embodiments, a panel or tile 400 is operatively coupled with the distal plate 300 and located thereupon. In this embodiment, a module 10 is composed of at least said panel or tile 400 operatively coupled with an origami parallel robot 100. The panel or tile 400 can have various shapes, designs and structures, depending on the needs and circumstances, which are functional for the operation of the multimodular system MMS, as well as of the single modules 10. As a way of example, in certain embodiments the panels or tiles 400 can be made of anti-slip materials to facilitate positioning of a user thereon, and can be sized accordingly; in other embodiments, one or more of the panels 400 of the MMS can be displays such as screens or LED displays, or can embed one or more sensors/additional devices such as movement sensors, microphones, audio speakers and the like. A plethora of different combinations and designs can be envisaged, which are easily accessible to a person skilled in the relevant art.

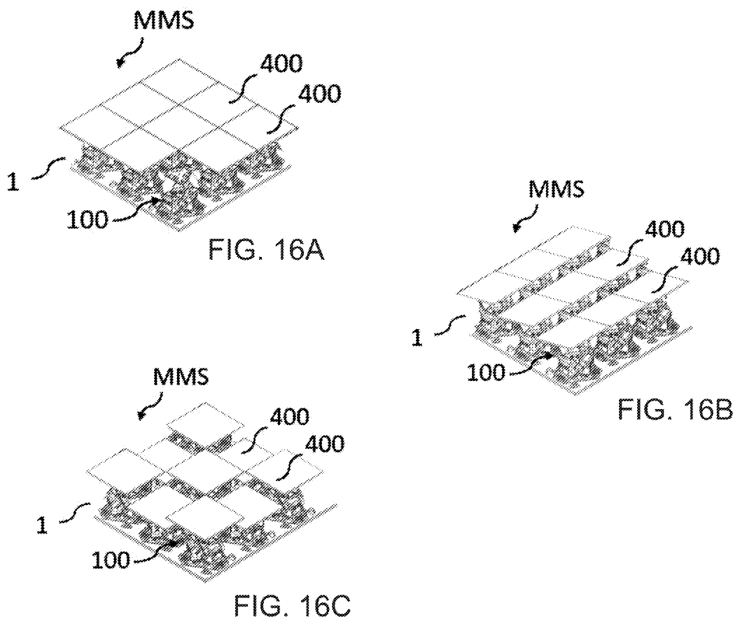

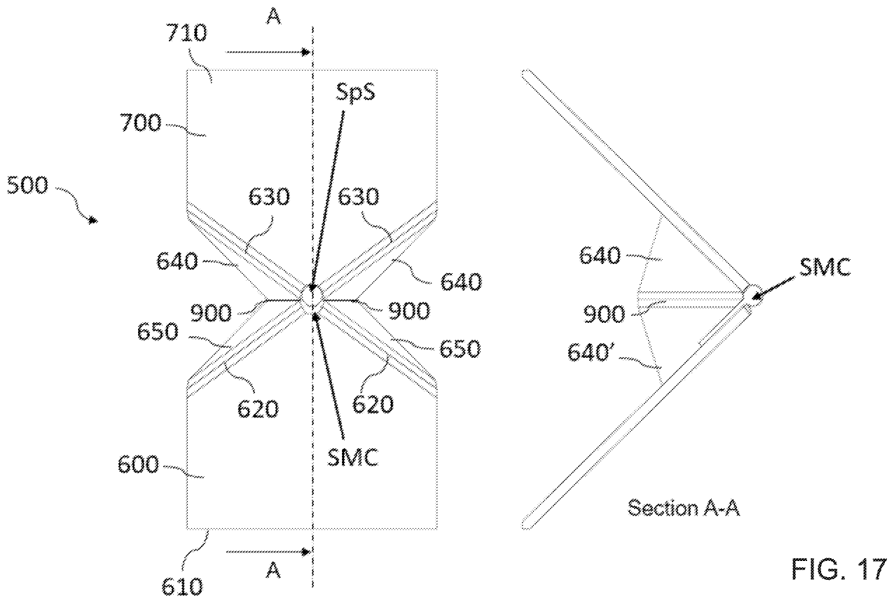

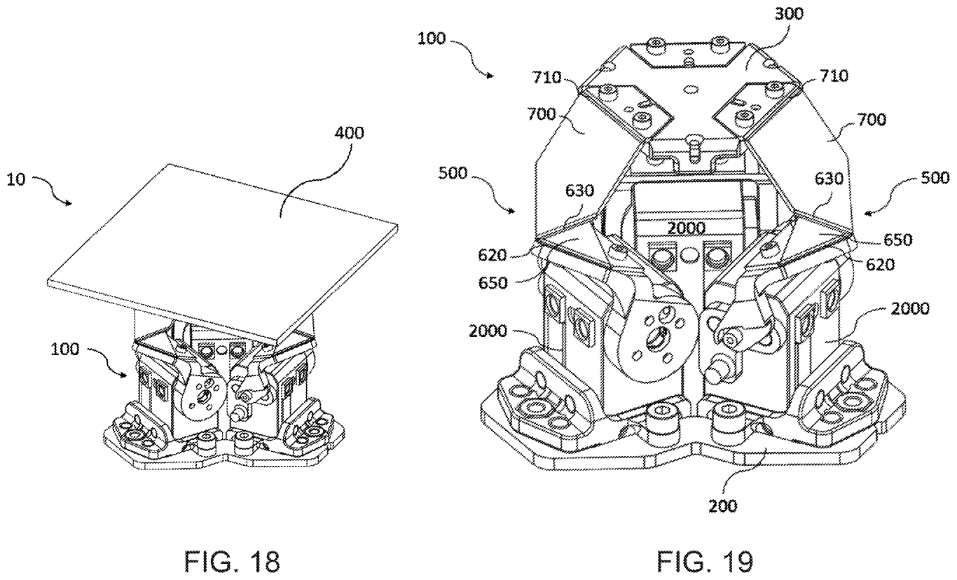

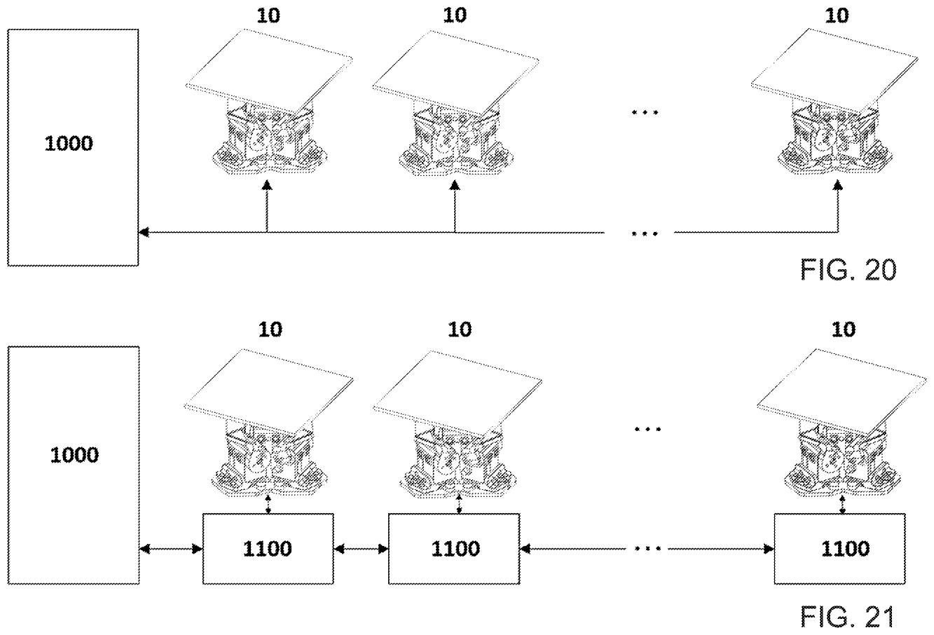

As shown in the Figures, a multimodular system may comprise a 3×3 array of modules (three rows and three columns) evenly disposed along a support 1 or a floor, thereby creating a grid (FIG. 16A-16C) of modules (FIG. 18). In the shown embodiment, the array of modules is located upon a flat support 1, and all the modules have the same shape and size of the human-bearing distal platform 400; however, any profile of a support 1 can be envisaged such as concave, convex, generally round and the like, and all or some of the modules can have one or more different sizes and shapes in terms of platforms 400 and/or parallel manipulator 100. Each of the modules comprise a rest position (cf. for instance FIG. 16A), that is a position in which no actuation trigger is provided, and at least one actuated position ((cf. for instance FIG. 16B and 16C), and when all the modules of the array are in the rest position, the entire system forms a surface following the profile of the support (such as a flat profile in the shown embodiment).

According to an aspect of the present invention, the electromechanical devices are used for performing the movement of a module 10. The origami parallel manipulators 100 according to some embodiments can be of various architecture and functionalities, depending on the needs and circumstances. For instance, origami parallel robots 100 can be included into the modules 10 of the system comprising different actuators mechanisms, different design and various functional features, linked for instance to the workspace to be addressed and the degrees of freedom (DoF) of the parallel robots 100. The degrees of freedom (DoF) of a mechanical system is the number of independent parameters that define its configuration. The position and orientation of a rigid body in space is defined by three components of translation (moving up and down, moving left and right, moving forward and backward) and three components of rotation (swivels left and right-yawing-, tilts forward and backward-pitching-, pivots side to side-rolling-), which means that it has six degrees of freedom.

For example, suitable origami parallel manipulators 100 do not need to have more than 4 DoF to deliver the appropriate motion effects of an entire system, without adding a surcharge of complexity in the manufacturing process and raising the costs.

One preferred embodiment of a module 10 comprising an origami parallel robot 100 having 2 rotational DoF and 1 translational DoF is shown in FIGS. 17 and 19, and comprises n limbs or legs 500, with n being at least two and preferably three, each limb or leg 500 comprising:
n basal linking members 600 pivotally attached via basal hinge joints 610 to a base plate 200 at first ends of the basal linking members 600, with the basal hinge joints 610 allowing a single DoF between each of the basal linking members 600 and the base plate 200;
n distal linking members 700 pivotally attached via distal hinge joints 710 to a distal plate 300 at first ends of said distal linking members 700, with said distal hinge joints 710 allowing a single DoF between each of said distal linking members 700 and said distal plate 300; and
a plurality of, such as two, connecting member pairs 640-650, each member 640 and 650 of said pairs being pivotally attached:
at a first end, to a corresponding basal linking member 600 at a second end of said corresponding basal linking member 600 via a first hinge joint 620; and
at a second end, to a corresponding distal linking member 700 at a second end of said corresponding distal linking member 700 via a second hinge joint 630
each member 640 and 650 of said pairs further comprising a third hinge joint 900, said first, second and third hinge joints 620, 630 and 900 of a limb 500 intersecting in a spherical motion center SMC of said limb 500. In certain embodiments, as the one shown in FIGS. 25 to 27, said spherical motion center SMC is a virtual, non-physical spherical motion center vSMC.

A spherical support SpS may be connected with the linking member 600 and positioned in the spherical motion center SMC to transmit forces between linking members 600 and 700 without overloading the hinge joints 620, 630, 900, thereby increasing the durability to fatigue of the hinge joints.

In one embodiment, a module 10 comprises N actuators, with N=n, (three for example) mounted in fixed relationship relative to a base plate 200 and being connected to the at least n basal linking members 600 for pivoting the basal linking members 600 about pivot axes of the basal linking members 600.

As a final result, the obtained kinematic chain provides for translational (moving up and down) and rotational motions of the distal plate with regards to the basal plate, thus permitting to obtain for instance a system in which each can perform for instance fluctuations, waves motion, vibration-like movements, swinging and the like upon appropriate coordination and synchronization.

Probably the most renowned 3 DoF parallel manipulator is the so-called Delta Robot, invented by Raymond Clavel in the '80s, see U.S. Pat. No. 4,976,582, this reference herewith incorporated by reference in its entirety. A Delta Robot enables the control of three translational degrees of freedom of a movable member in parallel from actuators arranged on a fixed support, while preserving parallelism of the moving member with respect to the fixed support. The basic idea behind the Delta robot design is the use of parallelograms: a parallelogram allows an output link to remain at a fixed orientation with respect to an input link. The use of three such parallelograms restrain completely the orientation of the mobile platform which remains only with three purely translational degrees of freedom. The input links of the three parallelograms are mounted on rotating levers via revolute joints. The revolute joints of the rotating levers may be actuated in two different ways: with rotational or linear actuators.

Controlled pivotal movement of each of the linking members 600 connected to the basal plate 200 can be achieved in a variety of ways. For instance, three actuators are mounted on the support plate, the actuators providing a net angular displacement of the basal linking member 600 it is operatively coupled with, the rotational axis of the actuator being parallel to the surface of the base plate 200. The actuators may be rotary or pure linear actuators converting linear motion into rotational motion. In embodiments, the actuators may be servomotors or pneumatic pumps. As a way of non-limiting example, actuators according to the present disclosure may be based on a rack-and-pinion mechanism and flat rotative motors. To actuate a slider of the leg a second actuation method can be implemented by using electric motors and a pinion for acting on a rack for linear transmission of the motion. Multiple actuators can be placed on the sides of the leg for magnifying actuation force and increase device compactness. Alternatively, the mechanical transmission can be implemented by using rotative motors that act on a pivot point, formed by bevel or conical gear joints, or by using a hinge-slider-crank arrangement, that transforms a linear movement into a rotation of the legs.

With consideration of motion characteristics of the spherical linkage in each limb 500 of the manipulator 100, an equivalent RSR kinematic chain is derived (wherein R and S stand for revolute joint and spherical joint, respectively). The common point as the intersection of axes of revolute joints is the spherical motion center of each equivalent spherical joint. The parallel structure is symmetric with respect to a virtual plane defined by centers of the three kinematic chains.

Thanks to the design of the above-mentioned connecting member pairs 640-650, and based on the alternating, synchronized or otherwise different movement provided by the actuators, the parallel origami manipulator 100 described is capable of producing pitch and roll motions possibly combined with a third plunging motion upon the variable actuation of actuators. The pitch and roll motions are angular motions of the distal plate 300, while the plunging motion is movement of the distal plate 300 toward and away from the basal plate. The 3 DoF mixed motion of this parallel manipulator 100 is uniquely determined by actuation ranges of the rotary or linear actuators, providing rotations up to 90°. Additionally, the internal hollow space defined by the limbs 500 can be exploited for embedding further elements such as cables, wires and/or electronic components.

According to some embodiments of the present invention, one or more modules 10 can comprise an origami parallel robot 100 having an additional rotational DoF, thereby forming a 4 DoF origami parallel robot. For instance, the basic design of a Delta robot as a parallel robot included into modules of the invention can comprise an additional fourth leg to transmit rotary motion from the base plate to an end-effector mounted on the movable distal plate. Alternatively, a rotary actuator can be operatively coupled to the basal plate to allow rotation of the entire module 10 upon need.

In order to provide all of the above-mentioned functionalities, according to some embodiments, a module 10 or a multimodular system MMS can further comprise an operatively coupled computing device 1000 configured to control the movement of the module 10 or of an array of modules, the computing device 1000 comprising a memory and a processing unit encoding instructions that, when executed, cause the processing unit to control the module 10 or array of modules (FIG. 20). An exemplary system for controlling the multimodular system MMS may comprise a computing device 1000 communicating with each of the modules 10 through a network. In this example, the computing device 1000 is a local or remote computing device, such as a desktop, laptop, or tablet computer. The computing device 1000 can use a standard wired or wireless communication protocol, such as Ethernet interface or Bluetooth, to control the modules 10 of the system. The control by the computing device 1000 can include programming the movement of each of the module assemblies. In an alternative embodiment (FIG. 21), the computing device 1000 can work as a “master board” providing instructions to command a network of “secondary boards” (or “slave boards”) 1100 acting independently on the associated modules in order to operate the same.

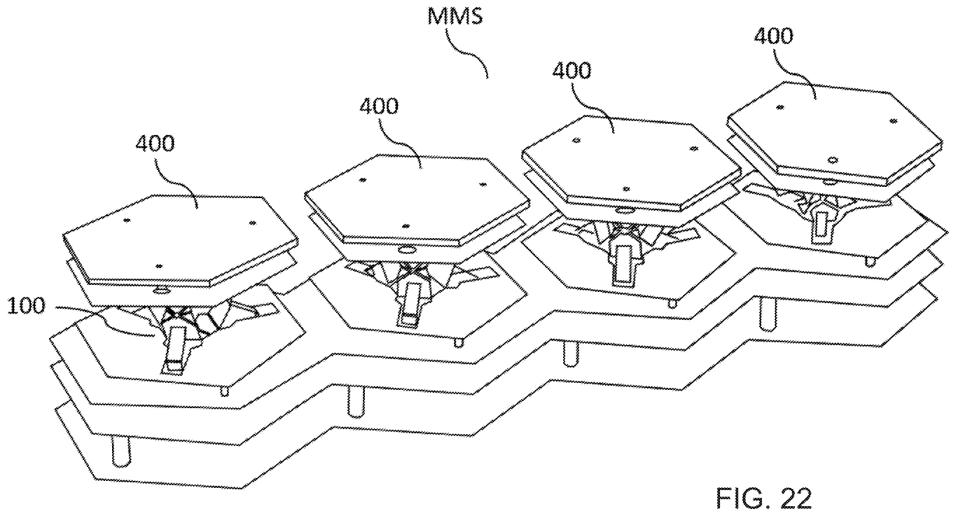

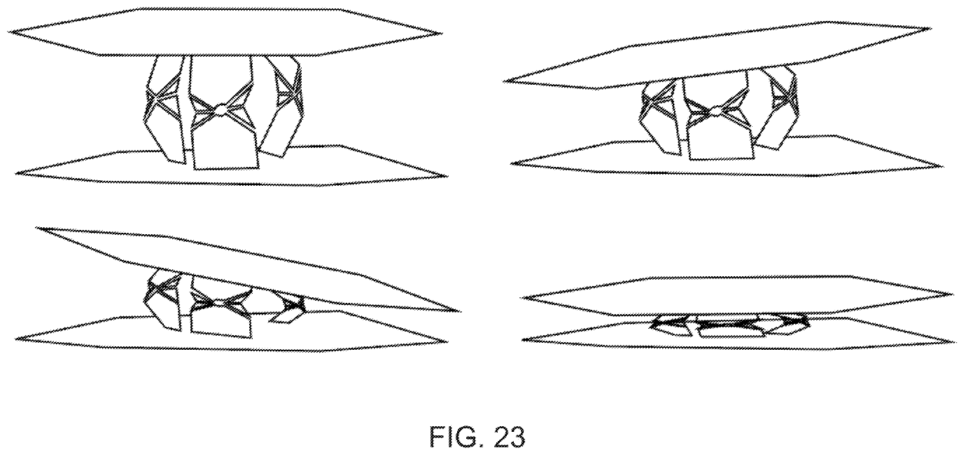

As a way of example, the modules 10 can be extended, retracted and/or tilted by pitch or roll motions, in one or more areas of the multimodular system MMS in coordination to provide for a motion of the entire multimodular system MMS, such as shown in FIGS. 16A-16C, 22 and 23. As it will be apparent to a person skilled in the art, a plethora of configurations and patterns are possible depending on the desired motions.

In these examples, the computing device 1000 may include one or more processing units and computer readable media. Computer readable media includes physical memory such as volatile memory (such as RAM), non-volatile memory (such as ROM, flash memory, etc.) or some combination thereof. Additionally, the computing device 1000 can include mass storage (removable and/or non-removable) such as a magnetic or optical disks or tape. An operating system and one or more application programs can be stored on the mass storage device. The computing device 1000 can include input devices (such as a keyboard and mouse) and output devices (such as a monitor).

According to some embodiments, the computing device 1000 can be further configured to control the movement of a module 10 or array of modules (MMS) based on an audio and/or video content. The audio content can be loaded on the computer device 1000 and combined with the video and motion components to obtain synchronized audio/video/motion files, or any suitable combination of the various contents.

According to some embodiments, the single module 10 or multimodular system MMS can further comprises an operatively coupled sensory system selected from a motion sensor, a velocity sensor, a touch sensor, a proximity sensor, a temperature sensor, a light sensor, a camera, a microphone, a force/torque sensor, as well as combinations thereof. The sensory system is operatively coupled with the computing device 1000, and in some embodiments the computing device 1000 generates contents based on a parameter sensed by the sensory system.

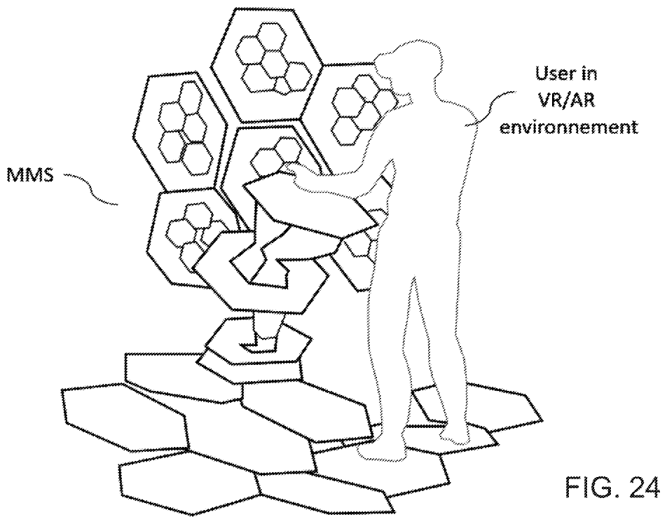

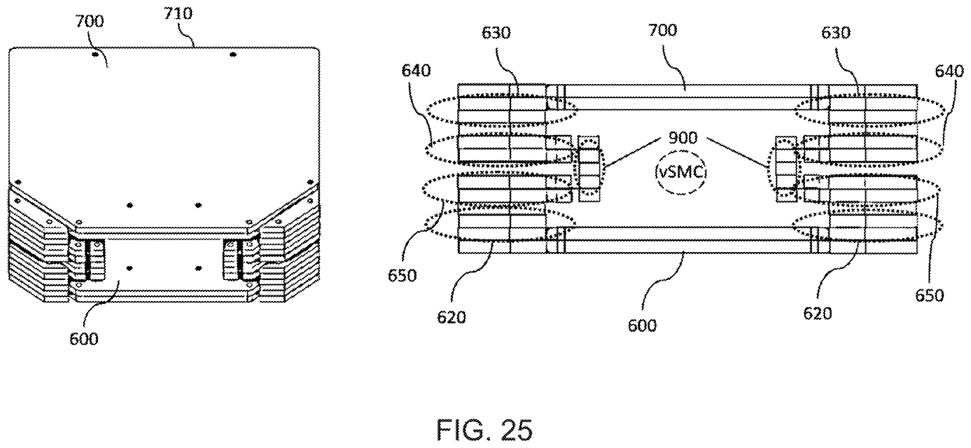

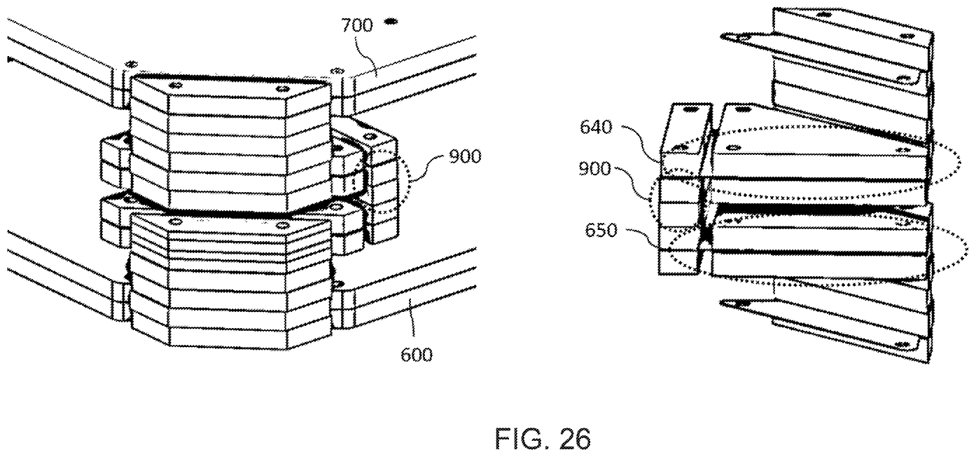

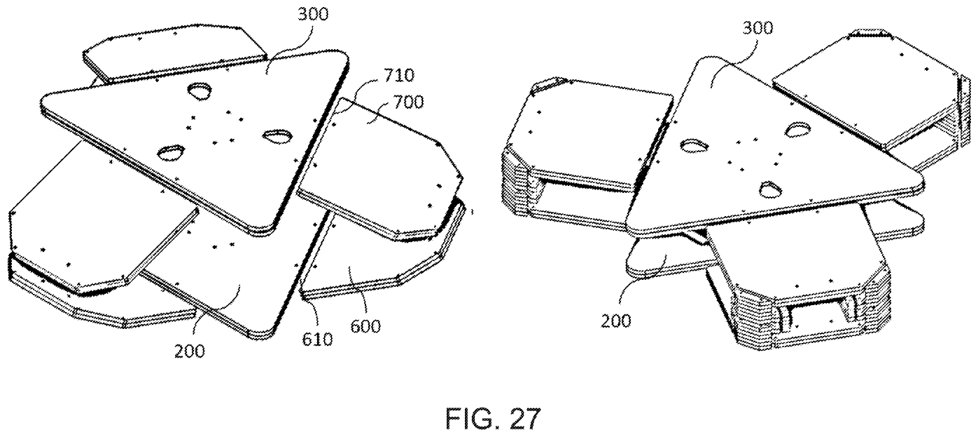

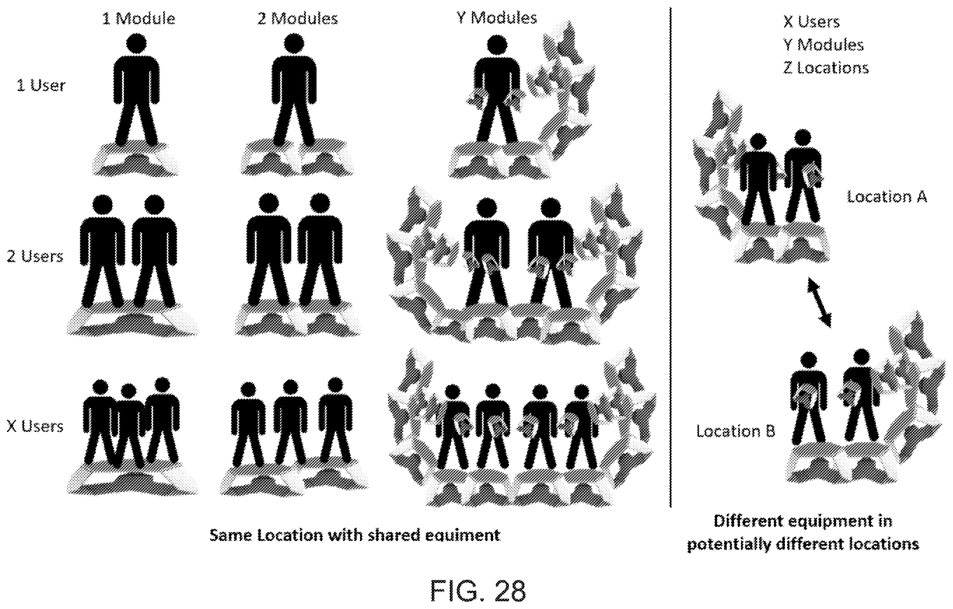

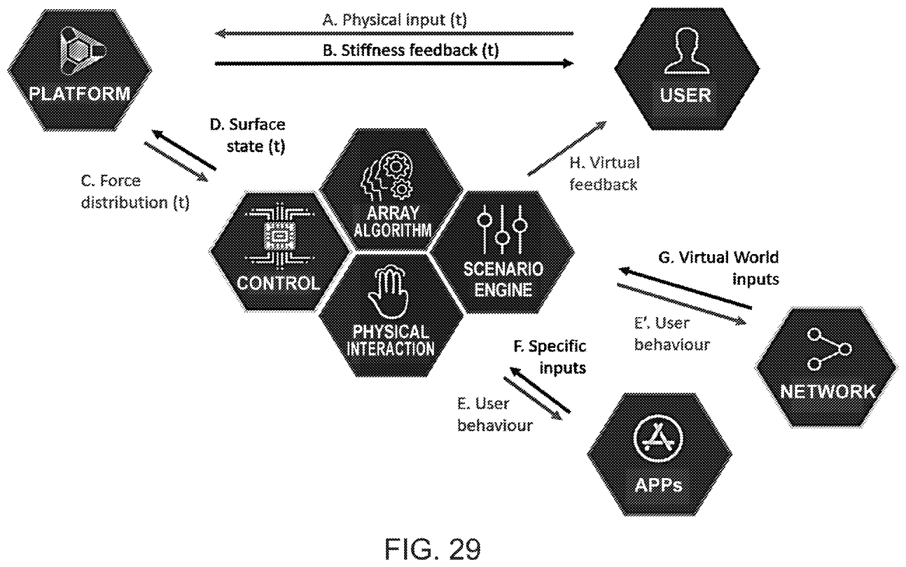

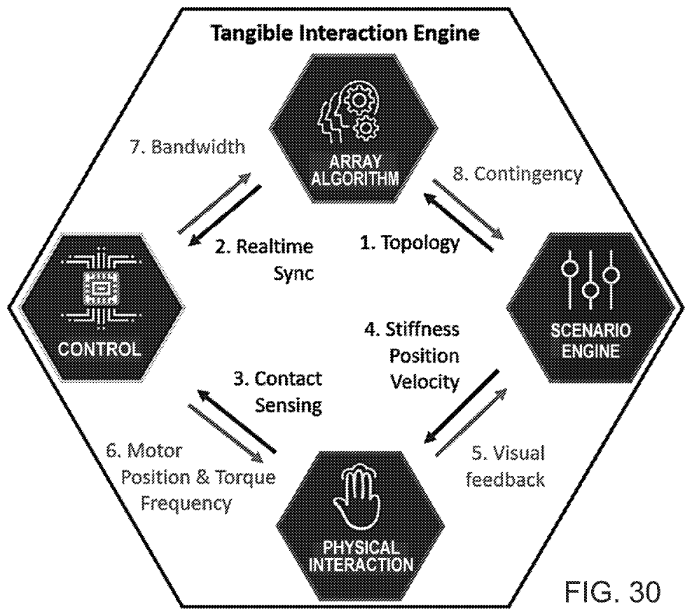

In addition, the system can including one module 10 or an array of modules MMS, and a computer device 1000 operatively connected thereto, and may further comprise additional elements configured and adapted for immersive virtual or augmented reality (VR/AR) experiences such as VR/AR goggles or headsets, and the computer device 1000 is adapted and configured to operate the module 10 or array of modules MMS to match with the virtual/augmented reality environment, as exemplarily shown in FIG. 24.

Linked with the above, another object of the invention relates to a distributed multimodular system, and associated interaction engine/method of operating said system, to create communication channels a user or set of users can exploit to interact in the physical world to items and environment in a virtual world, or between them in the physical world but at different physical location, trough force input and force, position and stiffness feedback distribution on a whole surface made of modules, used as an immersive and interactive artificial environment (FIGS. 28 to 30).

The interaction engine is linking the users as well as the physical platforms behaviour and inputs and feedbacks together, while also leveraging this set of information along time to external systems physically or virtually connected to the interaction engine to create additional, more specialized or diversly set, software or hardware application that can take advantage of the engine stream of data to bring an immersive experience or an interactive behaviour to a user or set of users.

Through a connected network of users or set of users, the interactive behaviour data stream and inputs and feedbacks can also be shared among users to interact among them to create a new tangible mean of communication including position, force, and stiffness exchange. This can be extended to interact with objects or with the environment either in a remote physical setting or in a virtual environment, still including force, position and stiffness interaction between the different items and the end user or set of users.

The interaction engine according to the invention is composed of 4 major components interlinked between them to distribute the data streams and to take decisions at various levels:
High-level Scenario engine, which is the element that coordinates the interaction engine for operations directly linking a user or set of users with an external network and with physical or virtual applications. Its role is to link the information and the data to the user's physical behaviour as well as the visual feedback;
Low-level Motors and Sensors Control, which handles the information from the sensors and the actuators and gives them the specific position and force requirements for the other parts of the interaction engine;
Mid-level Array Algorithmic Control, which handles the distribution and the physical position of the modules building an interactive multimodular surface. It also handles the interface between modules to create a continuous shape or stiffness distribution;
Mid-level Physical Interface Control, which handles the complete rendering of stiffness, force and position to the user and the human inputs to create a consistent physical interaction.

The tangible interaction strategy as well as the tangible interaction engine architecture and inner process have been developed to solve the currently unsolved issue of controlling a physical interactive surface made of a set of modules. The main application of this surface is to create immersive physical interaction between a platform or a set of platforms through a virtual or non-virtual environment.

The robotic surface made of several modules coupled with the proposed interaction engine and its inherent strategy allow to recreate distinctive distributions of stiffness, shape and force profiles through one module, a set of modules or a set of different location of modules.

The object of the invention allows to create proper tangible reality which permits not only to see a virtual environment but also to have a tangible physical interaction with it or with other human or virtual users or animated characters.

Human-machine interaction as conceived with the tangible interaction engine of the invention relies on the association of modular robotics and distributed software. In that perspective, modular robotics control & sensing are key components of the technology. The actuation and sensing system are completely independent of the number or physical entities through distributed actuation information and sensing. Considering a network of entities, with the number of actuators, sensors, and the kinematics, algorithms allowing to derive physical interaction through hardware as follows:
Physical interaction sensor data in the form of force and position feedback from the users are sent to the tangible interaction engine;
The tangible interaction engine handles data and processes them to take first order decisions directly dependent on the interaction mode selected and designed by the user, to create a first interaction level locally;
The tangible interaction engine distributes the physical interaction data directly to the corresponding physical entity through motion reconstruction, which differ from the usual strategy based on partial and differential motion reconstruction. The main aspect brought specifically by the tangible interaction engine of the invention is that the computation is done directly in a semi-centralized way. The addition of this extra layer gives an advantage in terms of control accuracy but limits the actuation rate with respect to the sensor input rate. To mitigate this effect, local processing capabilities on the platforms embeds partial reconstruction until the information from the centralized tangible interaction engine processing is received to adjust the behaviour of the robot. This allows to optimize simultaneously the speed of partial reconstruction as well as the accuracy of the control, which is central for human interaction;
The user receives physical feedback from the physical entity as well as visual feedback from the virtual environment in a simultaneous way.

To ensure responsiveness and application dependent interaction, a real time network is used to communicate with the different physical and virtual elements of the system. Of course, speed is a key component of such a network. User datagram protocol (UDP) commonly used is the fastest way to communicate in a network between a large set of entities. The main drawback from this protocol is data corruption and data reception from one entity to another.

To counter this effect, the strategy used according to the invention is to use a handshake between each data transmission, to ensure that packets are not corrupted using specific bytes to detect good reception or not of the entire packet. This strategy could result in a slowdown of the network data transfer. To prevent this from happening, the tangible interactive engine uses the following protocol for data transmission and reception during interaction:
Sensor data transmission: flooding a dedicated input data physical port of the network continuously on a time phase to ensure redundancy of transfer, without acknowledgment of reception;
Tangible interaction engine processes the packets locally using handshake strategy and discarding the packets if they are the same as the precedent one, in order to ensure redundancy but not duplicity;
Tangible interaction engine sends actuation commands flooding the dedicated physical port again without any regard of reception of the packet;
Networking layer between the tangible interaction engine and the physical entity used to sanitize the data flood discarding old information as well as making sure data is not corrupted using handshake strategy and ensuring coherency of data.

With this framework, interaction is ensured without consuming computing power on the processing unit on the physical entity's end, ensuring responsiveness and generalization of interaction protocol between software and hardware.

The proposed framework has to embed the possibility to add and remove entities from the network; this is achieved by referring each physical entity by an ID and a reset of the network every time some new entity sends a signal to enter or get out of the network, ensuring versatility and smooth interaction between an undefined number of physical entities with a user.

Elements on FIG. 29 are described herebelow. All the arrows represent data streams along time with potentially varying dataset sizes along time depending on actual usage or needs.

All transferred datasets, which may be system inputs or outputs as well as system states including the inner data stream between the user or set of users and the interactive physical entity or the set of physical entities, are function distributions that both vary along the space in 3 dimensions, as well as across time, to integrate both static and dynamic states and correlations of the various stakeholders. This includes the position, the topology, the force and stiffness distribution, the actuators and sensors states, as well as all the communication with a virtual environment and external entities.
A. Physical input function is the data stream headed from the user(s) to the whole span of physical interactive surface platforms across time. It is a wide dataset gathering the force, stiffness, position, sound, weight, movement, impulses, patterns and any other physical inputs on all the physical platforms in the network. It can also be the addition of several users' simultaneous inputs on different platforms, or even in different locations or any combination of those elements. The concept is to be able to retrieve the users' behaviour through their physical interaction with the surface platform and therefore feedback a stiffness, a force or a position achievable with the set of surface platform on their direct or not interactive environment. This dataset is the foundation of the interaction and the physical platforms behaviour and feedback but does not exist per se as it is the human behaviour;
B. The stiffness feedback data stream of the physical platforms to the users is the counter action of the platforms on the human's physical interactions along time. Stiffness is the variation of position depending on the force applied on an object. This is a metric very useful to create immersive understanding to the human body. Similar to the force inputs, the stiffness feedback is a stiffness distribution dataset of all the platforms in the network at a given moment. The data stream size can vary along time depending on the amount of modules involved in the interaction at a given time;
C. The force distribution data stream is the perceived force distribution sensed by any or all of the platforms on a full range of interactive physical systems made of platforms, which are a projection of the force input of the user(s) on the platforms both along time and along the workspace of the system which encompasses all the interactive physical entities, as well as the rest of the environment. This includes a force distribution function which takes into account the time, the location, the shape, the patterns, the motion, the impulses and the amount of contacts, as well as the stiffness and force of the contact distribution, along a space distributed surface. This is the dataset which will be used to compute the platform feedback position and force and that will be forwarded to the interaction engine core to be distributed and interpreted by the other stockholders;
D. The state of the surface data stream along time is the physical position feedback function of the set of physical interactive surface platforms which is able to give not only a position, but also a stiffness feedback to the users' interactive body. This is a time sensitive dataset which must be closely connected to the force distribution input to recreate a realistic and therefore immersive stiffness rendering;
E. The user(s) behaviour is the inner intelligence of the tangible interaction engine which retrieves the human behaviour and information input to distribute it to external stakeholders, building external applications, or other users across the network that need the human behaviour or real-time interactive behaviour with the platforms;
F. Specific inputs of the different stakeholders to bring a variety of different stiffness, position and force outputs on the platform while the user(s) are interactive with a definite platform;
G. Virtual World Inputs giving different physical feedbacks to users such as virtual environmental items or other users giving tangible interactive feelings;
H. Virtual feedback linked to the virtual environment going back to the users in a simultaneous manner as the stiffness feedback in B) to have a realistic and immersive interaction behaviour of the environment as well as the virtual environment output ranging including the visual output, the stiffness, vibrotactile and sound environment, and any other elements that are part of the virtual environment including any combination of those.

To go deeper in the tangible interaction engine described above, FIG. 30 shows a more detailed view of the inner data streams and decision process put in place to take all the various inputs from the user(s), the virtual environment, the external application stakeholders and to give a set of outputs that go from stiffness distribution outputs on the physical platforms, user(s) behaviour and visual virtual environment feedback to the user(s).
1. Topology is the physical configuration of the surfaces and modules at various scales and how they are placed in the physical world one to each other, may they be in contact or not. This concept takes into account both static and dynamic configuration as the topology may vary willingly or not along time in order to adapt both to the needs of the virtual environment or activities, and the external environment which may impact the use of the interactive physical systems. The rest of the static environment around those can also be part of the topology data to constrain the user motions possibilities or expected interactions.
2. Real-time Synchronization is the time rate and the different frequencies of all the subsystem that need to be taken into consideration, may it be physical elements such as actuators or sensors, software local aspects such as processing time and data transfer along the set of modules or the data stream coming from other locations through the network or external applications. All this is subsequent from the system topology.
3. Contact Sensing is the low-level information of the physical interaction part to the low-level control on the force and contact sensing on top of the platforms to perform a real time stiffness feedback through a direct position distribution control with respect to the force distribution applied on the whole system.
4. Stiffness, Position & Velocity are the inputs from the scenario engine to the physical interaction high-mid-level control which defines external factors of the virtual environment, other users and external applications to the physical interactive behaviour of the set of platforms. This allows to upgrade a basic feedback into a combination of local and global feedback of the platform to the users to have a truly immersive interaction between the users and the set of physical modules.
5. Visual Feedback is the mid-level information of the interactive behaviour where the force input of the users is eventually transferred back to the scenario engine in order to be applied to further visual feedback information for the own user but also for other users on the network.
6. Motor Position, Torque & Frequency are the information coming back from the low-level control to the mid-level physical interaction control in order to give the information on how the contact sensing is handled, and the feedback performed by the platforms.
7. Bandwidth is the information of the data rate, and the motion and sensing rates from the low-level control to the array algorithm.
8. Contingency is the array algorithm getting back on the scenario engine on the topology inconsistencies between the initial data and the perceived ones.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention is not limited to the described embodiments, and should be given the broadest reasonable interpretation in accordance with the language of the appended claims.

### REFERENCES

[1] Rus, D., Wood, R. J., Onal, C. D., & Tolley, M. (2017). Foldable Machines U.S. Pat. No. 9,686,867. Washington, DC: U.S. Patent and Trademark Office.
[2] Sreetharan, P. S., Whitney, J. P., Strauss, M. D., & Wood, R. J. (2012). Monolithic fabrication of millimeter-scale machines. Journal of Micromechanics and Microengineering, 22(5), 055027.
[3] Dufour, L., Owen, K., Mintchev, S., & Floreano, D. (2016, October). A drone with insect-inspired folding wings. In 2016 IEEE/RSJ International Conference on Intelligent Robots and Systems (IROS) (pp. 1576-1581). Ieee.
[4] Firouzeh, A., & Paik, J. (2015). Robogami: A fully integrated low-profile robotic origami. Journal of Mechanisms and Robotics, 7(2), 021009.
[5] Lee, D. Y., Kim, J. K., Sohn, C. Y., Heo, J. M., & Cho, K. J. (2021). High-load capacity origami transformable wheel. Science Robotics, 6(53).
[6] Melancon, D., Gorissen, B., García-Mora, C. J., Hoberman, C., & Bertoldi, K. (2021). Multistable inflatable origami structures at the metre scale. Nature, 592(7855), 545-550.
[7] Sun, X., Felton, S. M., Niiyama, R., Wood, R. J., & Kim, S. (2015 May). Self-folding and self-actuating robots: a pneumatic approach. In 2015 IEEE International Conference on Robotics and Automation (ICRA) (pp. 3160-3165) IEEE.
[8] Kozuka, H., Arata, J., Okuda, K., Onaga, A., Ohno, M., Sano, A., & Fujimoto, H. (2013). A compliant-parallel mechanism with bio-inspired compliant joints for high precision assembly robot. Procedia Cirp, 5, 175-178.
[9] Bottinelli, S., Henein, S., Aymon, C., & Clavel, R. (2002). Movement transmission unit and movement transmission apparatus employing the same. U.S. Pat. No. 6,453,566. Washington, DC: U.S. Patent and Trademark Office.
[10] Tazbaz, E. M., Hecht, A., & Ishihara, J. A. (2017). Multi-pivot hinge cover. U.S. Pat. No. 9,851,759. Washington, DC: U.S. Patent and Trademark Office.
[11] Vogtmann, D. E., Gupta, S. K., & Bergbreiter, S. (2011 May). Multi-material compliant mechanisms for mobile millirobots. In 2011 IEEE International Conference on Robotics and Automation (pp. 3169-3174). IEEE.
[12] Zhai, Z., Wang, Y., & Jiang, H. (2018). Origami-inspired, on-demand deployable and collapsible mechanical metamaterials with tunable stiffness. Proceedings of the National Academy of Sciences, 115(9), 2032-2037.

1. An electromechanical interactive module comprising:
an origami parallel robot;
a base plate operatively coupled with a first end of the origami parallel robot; and
a distal plate operatively coupled with a second end of the origami parallel robot.

2. The electromechanical interactive module of claim 1, wherein the origami parallel robot comprises:
n limbs or legs, with n being at least two, each limb comprising:
i) n basal linking members pivotally attached via basal hinge joints to a base plate at first ends of the basal linking members, with the basal hinge joints allowing a single DoF between each of the basal linking members and the base plate;
ii) n distal linking members pivotally attached via distal hinge joints to a distal plate at first ends of the distal linking members, with the distal hinge joints allowing a single DoF between each of the distal linking members and the distal plate; and
a plurality of connecting member pairs, each member of the pairs being pivotally attached:
i) at a first end, to a corresponding basal linking member at a second end of the corresponding basal linking member via a first hinge joint; and
ii) at a second end, to a corresponding distal linking member at a second end of the corresponding distal linking member via a second hinge joint each member of the pairs further comprising a third hinge joint, the first, second and third hinge joints of a limb intersecting in a spherical motion center of the limb.

3. The electromechanical interactive module of claim 2, further comprising N actuators, with N=n, mounted in fixed relationship relative to a base plate and being connected to the at least n basal linking members for pivoting the basal linking members about pivot axes of the basal linking members.

4. The electromechanical interactive module of claim 2, wherein n=3.

5. A multimodular system comprising a plurality of electromechanical interactive modules of claim 1.

6. The multimodular system of claim 5, wherein the modules comprise a rest position and at least one actuated position, and wherein, when all the modules of the array are in the rest position, the entire system forms a surface following the profile of a support it is located on.

7. The multimodular system of claim 5, wherein at least some of the modules comprise a 3 degrees of freedom (DoF) origami parallel robot.

8. The multimodular system of claim 7, wherein the origami parallel robot has 2 rotational DoF and 1 translational DoF.

9. The multimodular system of claim 7, wherein at least some of the modules further comprise an origami parallel robot having an additional rotational DoF, thereby forming a 4 DoF origami parallel robot.

10. The electromechanical interactive module of claim 1, further comprising an operatively coupled computing device configured to control the movement of a module or the array of modules, the computing device comprising a memory and a processing unit encoding instructions that, when executed, cause the processing unit to control the module or array of modules.
